(19) United States
(12) Patent Application Publication
(10) Pub. No.: US 2020/0101495 A1
(43) Pub. Date: Apr. 2, 2020

(54) AIR CLASSIFIER WITH A CYCLONE-LIKE EFFECT FOR WASTE MANAGEMENT APPLICATIONS

(71) Applicant: DIRK BARNSTEDT, Rötha (DE)

(72) Inventor: DIRK BARNSTEDT, Rötha (DE)

(21) Appl. No.: 16/145,874

(22) Filed: Sep. 28, 2018

(51) Int. Cl. B07B 7/086; B07B 4/02; B65G 53/60; B07B 7/04

(52) U.S. Cl. CPC B07B 7/086; B07B 7/04; B65G 53/60; B07B 4/02

(57) ABSTRACT

The here present invention introduces a method and a device applying said method for the separation of a primarily heterogeneous material stream, as commonly encountered in the waste management industry. The device primarily constitutes a housing which features a cylindrical component, into which a gas stream is introduced by means of a gas injection nozzle, which passes through the material stream, which contains individual fractions at least once. Due to the specific curvatures of the cylindrical housing part and the specific arrangement of several flow control elements as well as the associated interaction of the undisturbed laminar gas/material stream with the separation of the individual fractions in the interior of the housing, a compact design of the device as well as a high degree of separation can be achieved.

The invention here present concerns an air classifier with a cyclone-like effect, particularly intended for the waste management industry, in which a heterogeneous material stream is separated into its individual constituent fractions, whereby an almost perfect degree of purity of a given fraction of the material stream is achieved.

A device of this nature is known to the state of the art from WO 2013/102451 A1. This document discloses a method and a device based on this method, which are intended for the separation of a heterogeneous material stream as typically encountered in the waste management industry. The device primarily consists of a housing with a cylindrical component, into which a stream of gas is introduced by means of a gas nozzle. This stream passes through the material stream at least once, whereby it transports the individual fractions of the material stream to a guide element at which a separation of at least two fractions occurs, before the gas/material stream is guided to the cylindrical housing component which features a specific curvature. A second guide element with a curvature pointing into the opposite direction is located at the end of the cylindrical component, thus creating an overall flow similar to the shape of an S, which is used to extract a desired lightweight fraction across the surface. It is considered a disadvantage of this method and of devices based on this principle that at certain locations within the housing the otherwise laminar gas/material flow will generate eddies within the flow. These eddies lead to unnecessary material losses as well as a loss of the energy needed to create the individual gas flows within the housing, thereby having a substantial negative effect on the degree of efficiency of the device as well as on its energy consumption.

Furthermore, publication DE 44 418 A1 has been disclosed into the state of the art, which describes a centrifugal chamber for the viewing of plant matter such as e.g. tobacco or herbs, in which two different air flows with different flow speeds stream tangentially into the centrifugal chamber, which is designed as a lying drum, where they merge in the form of eddies along the cylindrical wall surfaces. The purpose of these eddies is to prevent clumping of the introduced plant matter.

Furthermore, U.S. Pat. No. 2,643,769 A has become known as part of the state of the art. This publication discloses a method and a device which are suitable to pneumatically separate granulated materials into light-weight and heavy materials using a snake-shaped airflow through a multi-part separator housing. In this process, the primary injected air/material stream is separated into a pure air stream and an air/material stream immediately upon entering a chamber. In this, the pure air stream is routed through a separate line whose end is positioned below the air/material stream, so that the discharged pure air stream from the line passes through the granulate stream consisting of heavy and light-weight fractions, thereby forcing the light fractions upwards. The air stream exiting the end of the line is then divided into two different air/material streams by a separator element, whereby one of the air/material streams has a valve placed at its top end which is designed as a butterfly valve. The purpose of this butterfly valve is to throttle this air/material stream as needed, in order to control the flow rate of the air/material stream through a passage B.

Publication U.S. Pat. No. 3,836,085 also shows an elongated housing with a cylinder-like component in which particles of different densities are separated, however, basically only into two fractions.

Furthermore, DE 298 21 221 U1 made known within the state of the art a device with a housing drum which has an inlet opening through which an air stream containing particles to be separated which glide along the housing drum wall is introduced, unless they have already been extracted through screen perforations in the housing wall based on their size. This means that items with large surfaces such as film sheets are captured by the air stream and will then be ejected from the housing as large-surface parts through an ejector opening in the drum wall after traversing approx. 270° of the wall. Within this housing drum, a so-called cellular wheel is placed which can rotate and features a multitude of blades which, among other things, effect a regulation and slowing of the air stream, which in turn limits the speed the captured large-surface fractions of the material stream achieve within the drum to a preset value. This has a negative effect on the degree of separation achieved for the parts to be separated.

EP 694 28 273 T2 discloses a waste treatment method, in which the entire material stream is initially processed into uniform particles, and is then separated into three different material streams inside a cyclone separator; one each for light, medium and heavy particles.

Another device, among others, has become known within the state of the art from publication DE 196 30 472 C2, which discloses a cyclone separator for the separation of particulate materials from gas streams, which features a cylindrical housing component with an attached cylindrical inlet body with an inlet pipe. There, so-called disruptor elements are arranged on the inside walls of the cylindrical housing component, which are intended to have a disrupting effect on the laminar flow of the gas/particle stream within the entering flow. Below the cylindrical housing part, a funnel-shaped housing part is attached which introduces a secondary air stream into the cylindrical housing part, thereby effecting an improvement of the separating function. An ejector pipe is placed above the funnel-shaped housing part, which basically evacuates the entire gas stream from the housing. This device is, however, only suitable for the cleaning of gases in which smaller particulates are to be separated from the gas stream. This type of cyclone classifier is not suitable for separating large-surface material streams.

Furthermore, an air classifier system has become known within the state of the art, which is used for materials of different specific weights contained inside a material mix, as is commonly encountered in material streams in waste management. This publication DE 20 208 001 933 U1 primarily describes a transport device with a viewing drum arranged at its end, whose rotational axis is transverse to the transport direction. Below the transport device, between the end of the transport device and the viewing drum, an air bubble device is installed which permeates the falling material stream and thereby captures at least the light-weight fractions of the material stream. The remaining fraction of the material stream then separates into medium- and heavy-weight materials, whereby the medium-weight materials land on the surface of the viewing drum where they are transported further. The air stream discharged from the air bubble device guides the light- and medium-weight material fractions through a flow channel which has a collector device attached at its end, thereby separating the material stream into heavy-, medium- and light-weight material fractions. It is a perceived disadvantage of this device that the design and layout of such a plant has to be comparatively long in order to make the individual separation elements effective at all. Furthermore, it does not necessarily guarantee a high degree of separation between light- and medium-weight material fractions.

The purpose of this present invention is therefore to provide a method and a device which are capable of, in a simple manner, almost completely separating at least one fraction from the heterogeneous material stream of a dry bulk, in order to meet the requirements of the waste management industry.

This task is solved by the characteristics described in the main claims in accordance with the invention.

The method according to the invention for the complete separation of light-weight laminar fractions from the heterogeneous material stream, which contains a multitude of different fractions, and with a material stream which is guided to a housing, into which at least one gas stream is introduced which passes through the material stream introduced into the housing at least once, thereby capturing at least one light-weight fraction to then guide it along at least two guide elements on an S-type-shaped laminar flow path, at whose end section at least one suction extractor for at least one fraction is installed, whereby at least two guide elements are placed in the inlet area of the suction extractor, whose curvature with a specified radius r2, r3 points into the same direction and the curvature of radius r2 pointing into the opposite direction of the curvature of radius r1 of the cylindrical part of the housing (3).

In this design, it is advantageous that at least one curved guide element with a specific curvature radius is placed at the end of the cylindrical housing part in the area of the suction extractor device.

Another advantage is that at least two guide elements are arranged in such a manner that no eddies are generated in the flow, which would otherwise have a disruptive effect on the laminar S-shape-type flow. The specific arrangement of the guide elements achieves a complete preservation of the laminar gas/material stream in the inlet area of the suction extractor device.

It is furthermore advantageous that at least one guide element is made of a non-oxidizing material, preferably stainless steel, which mostly prevents the forming of chemical bonds on the surface of at least one guide element.

It is crucial that the side walls of the housing feature at least one angled structure which spans, at a specific location, the lateral housing walls vertically and/or horizontally. This guarantees the structural stability of the housing on one hand, while preventing vibrations that could disruptively affect the laminar gas/material stream inside the housing on the other.

It is also considered an advantage, that at least two separation processes are generated inside the housing, of which at least one separation process only separates light-weight laminar partial fractions along the S-shaped laminar gas flow path, and that the S-shaped laminar stream is generated along the gas routing elements due to the special smooth, seamless and lossless geometric design.

It is furthermore advantageous that of the at least two separation processes within the housing at least one separation process at a certain location will only separate light-weight laminar partial fractions due to the S-shaped laminar gas stream.

Another advantage is that the gas/material stream is routed to a guiding element at least once before it is guided into a flow path resembling a circular path.

The device according to invention for the separation of a heterogeneous material stream, preferably in the waste management industry, consists of a multi-component housing, of which one component is designed cylindrically and features at least one gas injection nozzle and at least one suction extraction unit, in which the gas stream ejected from the minimum of one gas injection nozzle passes through the material stream at least once and thus captures at least one material fraction to then transport it into the direction of the at least one cylindrically shaped housing wall, and then, due to the curvature of the housing wall, guides it into the direction of the at least one suction extraction unit, whereby at least one adjustable control element is placed inside the housing below the cylindrically shaped housing wall which controls at least one gas/material stream with respect to direction and speed before it is guided to the cylindrical part of the housing in a circular-flow-resembling path, whereby at least two guide elements are located in the intake area of the suction extraction unit, whose curvatures point into the same direction, which generates a laminar flow which is virtually free of any eddies.

An advantage thereof is that at least one part of the housing is designed cylindrically with a specified curvature radius, along which at least one fraction of the material stream is captured, transported and accelerated by the gas stream.

It is furthermore advantageous that the circular-arc-like inner wall of the cylindrically shaped part of the housing features a predetermined curvature radius r1.

It is beneficial to the degree of purity of the separated fractions that at least one gas injection nozzle and at least one suction extraction unit which only extracts one fraction are placed at the end of the cylindrically shaped part of the housing.

It is considered another advantage that at least one curved and adjustable flow control element is placed at the end of the cylindrical housing component, which, at least in the vicinity of the extractor channel, controls the gas/material stream with respect to direction and speed.

It is furthermore advantageous that the suction extraction unit is placed tangentially in the end section of the circular-arc-like flow pattern of the gas/material stream.

It is also advantageous, that the suction extraction unit of the cylindrical housing component is located on the curved housing wall in the area of a circular flow pattern motion of the material stream of 60° to 220°, preferably between 90° and 200°.

It is furthermore an advantage that the end of at least one means of conveyance is placed adjustably in the area of the intake opening of the housing.

It is also advantageous that at least one means of conveyance is located below the primary gas flow.

Another advantage is seen in the fact that the housing features at least one maintenance hatch which can be used to, i.a., perform small repairs and to have a look into the ongoing operation.

Of very distinct advantage is the fact that the line along the cylindrical housing part and the guide elements in the vicinity of the suction extraction unit resembles an S-shape, meaning, an imagined line within the gas/material stream takes an S-shape.

The following will further explain the invention in detail by using drawings. It shows

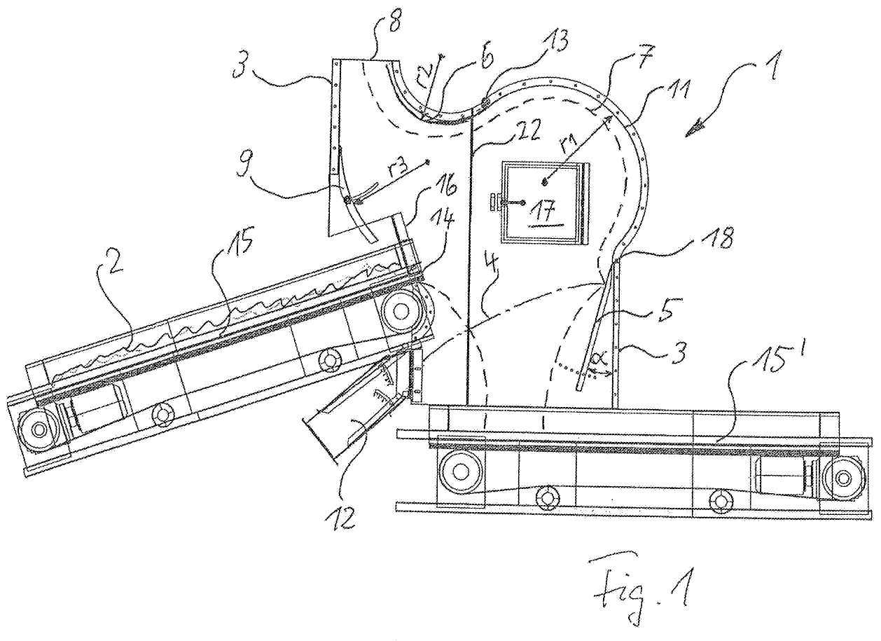

FIG. 1 a schematic lateral view of a device according to the invention (1) within a plant, in which the device (1) is fed with a heterogeneous waste management material flow (2) by means of a conveyor belt (15) for the purpose of separating the individual fractions (2′, 2″, 2′″);

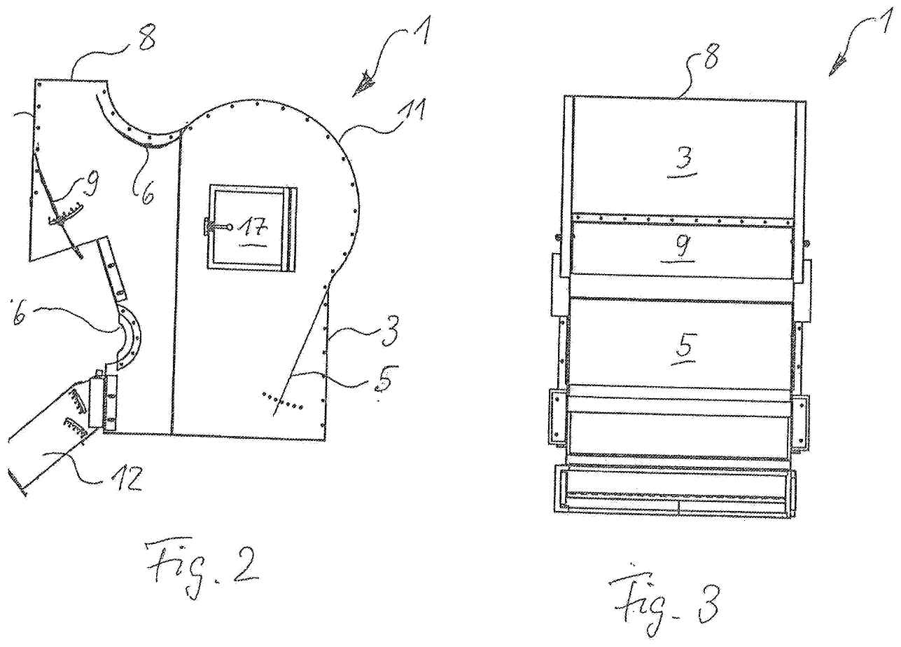

FIG. 2 a schematic lateral view of the device (1), in which the essential guide elements (5,6,9) are arranged within the housing (3);

FIG. 3 a schematic front view in the direction of the inlet opening (16) of the front of the first guide element (5) and the rear of another guide element (9);

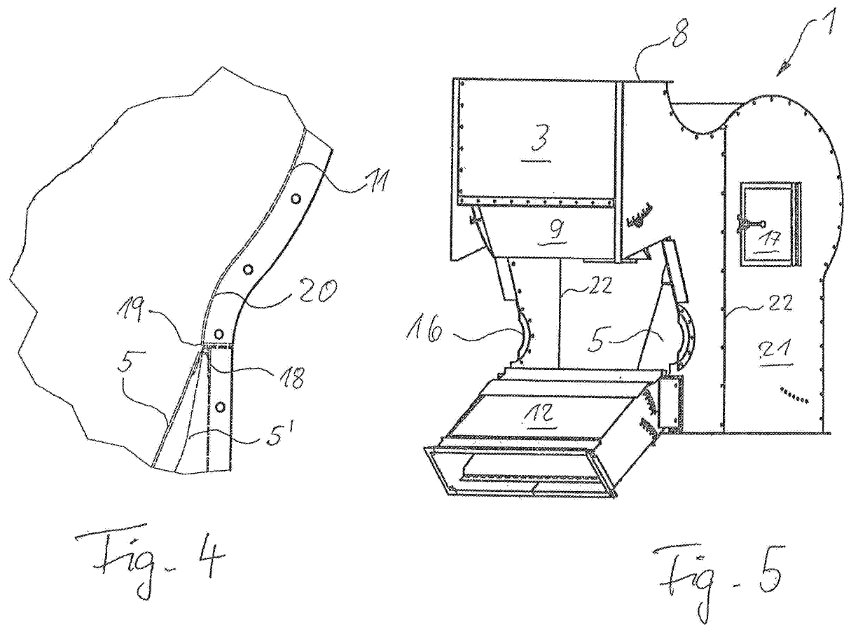

FIG. 4 a schematic detail view of the connection area between the first guide element (5) and the cylindrical part (11) of the housing (3);

FIG. 5 a perspective schematic representation of the device (1) with a view of the inlet opening (16) in the housing (3);

FIG. 1 shows a schematic lateral view of a design example of a device according to the invention within a plant, in which the device 1 is fed with a heterogeneous material flow 2 by means of a conveyor belt 15 for the purpose of separating the individual fractions 2′, 2″, 2′″; The conveyor 15 is used to transport the heterogeneous material flow 2 in a direction towards the inlet opening 16 of the housing 3. The housing 3 constitutes several parts and areas, which represent a combined compact housing 3. A suction extraction unit 8 is arranged on the housing 3, which is used to extract, almost exclusively, the light-weight laminar fractions 2″ of the material stream 2. The heavy- and medium-weight fractions 2′ and 2″ are separated in the interior of the device 1 in at least two separation processes, and are transported away at least in part by the conveyor 15 positioned below. Between the upper conveyor 15 and the lower conveyor 15, at least one gas injection nozzle 12 is located, which injects the gas volume 4 required to separate the individual fractions of the material stream 2 into the housing 3, whereby it passes through the material stream 2 at least once. A maintenance hatch 17, which can also be designed as a window, is located on the side of the housing. The unique characteristic of the device 1 is, on one hand, the cylinder-shaped part of the housing wall 11, which imparts a cyclone-like effect on the gas/material stream, and, on the other hand, the particular arrangement of the gas flow guide elements, which force the gas/material streams inside the housing into at least two non-rectilinear flow directions.

The classifier device 1 therefore primarily consists of a housing 3 which features a cylindrically curved part 11. At the end of the cylindrically curved housing part 11 a suction extraction unit 8 is placed, which extracts the majority of the injected gas 4 through an extraction channel. The primary heterogeneous material stream 2 is fed into the housing 3 through an opening 16 at the end 14 of the conveyor 15. Below the end 14 of the conveyor 15 and the falling heavy fractions 2′ of the primary heterogeneous material stream 2, there is a gas injection nozzle 12 whose flow 4 is directed in an arc towards the entry into the cylindrical part 11 of the housing 3, so that the light-weight 2′″ and medium-weight 2″ fractions of the heterogeneous material stream 2 are captured when it transverses the heterogeneous material stream 2, to then be guided to an adjustable flow control element 5 which is attached to a movable joint 5′. Upon impact of the laminar light—2′ and medium-weight 2″ fractions, another separation between light-weight and medium-weight fractions of the material stream occurs, whereby the medium-weight material fraction 2″ falls down due to gravity and the impact with the flow guide element 5, whereby it is routed to another conveyor 15 which is located below the device 1. The light-weight laminar fractions 2′ with a small residual part of the medium-weight fractions 2″ are captured by the primary gas flow 4 and guided by the cylinder-shaped arched housing wall 11 into a circular flow in which they are accelerated. The guide element 5 inside the housing part 3 is adjustably arranged and, in one design example, fixed on a hinge in the area of the inlet of the cylindrical part 11 of the housing, so it can swivel. By adjusting the angle α between housing wall 3 and the guide element 5, the gas/particle stream 2′, 2″ is optimized so that the gas/particle stream is not subjected to unnecessary turbulences and so that the medium-weight matter is sorted out optimally. The initial separation process between heavy-weight matter 2′ and light-weight to medium-weight matter 2″, 2′″ occurs when the primary material stream 2 falls into housing 3 already, because the gas flow is adjusted so that the falling heavy matter 2′ is only marginally affected with respect to its flow pattern and therefore lands directly on the conveyor 15 located below. Once the gas/material stream 2″, 2′″ has traversed an approximate flight path angle of 130° on a cyclone-like circular path along the cylindrical housing wall 11, a suction extraction unit 8 is placed on this location of the circular-arc-shaped housing part 11, which extracts the injected gas volume of flow 4 together with the light-weight laminar fractions 2′″.

At the end 13 of the cylindrical housing part 11, another adjustable guide element 6 is placed, whose curvature points into the opposite direction of the curvature of the cylindrical part 11 of the housing with a curvature radius r2, so that the medium gas/material stream 7 is forced onto a laminar S-shaped course. The laminar course of the gas/material stream is, depending on the type of fractions to be separated, controlled by guide element 6 in conjunction with another guide element 9, which is essential and very important to a laminar stream in order to, on one hand, guarantee the laminar flow of the gas/material stream and, on the other hand, to keep energy losses caused by turbulences as low as possible. The optimization of the laminar flow is only ensured when the additional guide element 9 is arranged approximately opposite the guide element 6, whereby the curvature radius r3 of guide element 9 points into the same direction as the curvature radius r2 of guide element 6, whereby laminar properties are forced onto the entire flow pattern.

Thus, in the extraction process, the imagined flow line 7 of the gas/material stream is, by means of at least one additional adjustable flow control element, guided into an S-shape-like linear stream, which effects an additional separation process with a high degree of purity between the laminar light-weight 2′ and the residual medium-weight 2″ material fraction. The separation process is based on the physical principle that the medium-weight fractions 2″ have been accelerated by the circular movement to such an extent that the kinetic energy of the particles has become so much that the suction extraction unit 8 cannot redirect them from their circular flight path. Thus, a separation takes place at this particular location of the circular motion in which pure large-surface light-weight fractions 2′″ are separated from medium-weight fractions 2″, so that, as a result, the suction extraction unit 8 will only extract the laminar light-weight fractions 2″. Additional flow control elements can be arranged within the suction extraction unit 8 in order to affect the degree of separation and the flow direction. The stream within the suction extraction device 8 now only contains the laminar fractions 2″, such as e.g. film parts contained in the primary heterogeneous material stream 2, which results in a degree of separation between light- and medium weight fractions between 95 and 100 percent at an equal yield.

FIG. 2 shows a schematic lateral view of the device 1, in which the essential guide elements 5,6,9 arranged within the housing 3 can be seen; The movable and adjustable guide element 5 is placed below the cylindrical part 11 of the housing 3, whereby it can be fixed by means of a hinge, for example. It is of essential importance to the laminar flow of the gas/material stream that the transition between guide element 5 and the cylindrical housing part 11 is virtually seamless in order to prevent turbulences and their associated losses. Furthermore, the additional guide element 6 is arranged behind the housing part 11, whereby the curvature of guide element 6 points into the opposite direction to that of the cylindrical part 11. Furthermore, another guide element 9 is located inside the inlet area of suction extraction unit 8, whose curvature with the radius r3 points into the same direction as the curvature of guide element 6 on the almost opposite side of the extraction channel. When dimensioning the length of the guide element 9, it must be ensured that the length does not cause eddies within the flow, as they would cause unnecessary losses. The interaction of the above-describe particular arrangement of the individual guide elements 5,6,9 with the cylindrical part 11 of housing 3 facilitates and extremely compact design of device 1.

FIG. 3 shows a schematic front view in the direction of inlet opening 16 of the first guide element 5. This representation of device 1 corresponds to the representation in FIG. 2 rotated by 90°. Guide element 5 is made of a smooth material, preferably stainless steel, in order to offer as little attackable surface of guide element 5 to chemical bonds as possible. Guide element 6, which has been described in detail above and has a predetermined curvature, is arranged above guide element 5. Above guide element 6 the suction extraction device 8 is located, which serves the purpose of extracting the laminar fractions 2′″.

FIG. 4 shows a schematic detail view of the connecting area between the first guide element 5 and the cylindrical part 11 of the housing 3. The first guide element 5 is affixed to the housing 3 with a hinge 18 at the upper end and can be rotated. The hinge is placed below a protrusion 19 on the housing 3, which forms a seamless and smooth transition which does not create any unevenness in the profile of the guiding walls, which in turn prevents eddies in the generation phase of the laminar gas/material stream, which have far-reaching consequences for the continuing flow behavior and can furthermore cause significant energy losses. Furthermore, the transition area 20 to the cylindrical part 11 of the housing 3 is designed with an arc, in order to ensure that a laminar gas/material stream 7 forms which causes little or no losses.

FIG. 5 shows a perspective schematic representation of the device 1 with a view of the inlet opening 16 and guide elements 5 and 6. A maintenance hatch 17 is placed in the side wall of the housing 3, through which a view of the interior of the housing 3 is possible during operation and which can be used to perform minor repair work. Furthermore, an angled structure 22 spans the entire side wall 21 in a vertical direction, providing mechanical stability. This angled edge structure can be arranged vertically as well as horizontally.

It summary it can be concluded, that the here present invention discloses a method and a device (1) applying said method for the separation of a primarily heterogeneous material stream (2), as commonly encountered in the waste management industry. The device (1) primarily constitutes a housing (3) which features a cylindrical component (11), into which a gas stream (4) is introduced by means of a gas injection nozzle (12), which passes through the material stream (2), which contains individual fractions (2′, 2″, 2″), at least once. Due to the specific curvatures of the cylindrical housing part (11) and the specific arrangement of several flow control elements (5,6,9) as well as the associated interaction of the undisturbed laminar gas/material stream (7) with the separation of the individual fractions (2′, 2″, 2′″) in the interior of the housing (3), a compact design of the device (1) as well as a high degree of separation can be achieved.

1. A method for the complete separation of light-weight laminar fractions (2′″) from a heterogeneous material stream (2) which contains a multitude of different fractions (2′, 2″, 2″), whereby the material stream (2) is guided to a housing (3), into which at least one gas stream (4) is introduced which passes through the material stream (2) introduced into the housing (3) at least once, thereby capturing at least one light-weight fraction (2′″) to then guide it along at least two guide elements (5,6,9,11) on an S-type-shaped laminar flow path (7), at whose end section at least one suction extractor unit (8) for at least one fraction (2′″) is installed, whereby at least two guide elements (6,9) are placed in the inlet area of the suction extractor unit (8), whose curvature with a specified radius (r2, r3) points into the same direction and the curvature of radius r2 pointing into the opposite direction of the curvature of radius r1 of the cylindrical part (11) of the housing (3).

2. The method according to claim 1, wherein at least one curved guide element (9) with a specific curvature radius r3 is placed at the end of the cylindrically shaped housing part (11) in the area of the suction extractor device (8).

3. The method according to claim 1, wherein at least two guide elements (6,9) are arranged in such a manner that they do not produce any flow vortices which would have a disrupting effect on the laminar S-shape-type flow pattern (7).

4. The method according to claim 1, wherein at least one guide element (5) is made from a non-oxidizing material, preferably stainless steel.

5. The method according to claim 1, wherein the housing (3) features at least one edged structure (22) which spans through the housing (3) at a predetermined location vertically and/or horizontally.

6. The method according to claim 1, wherein at least two separation processes are generated inside the housing (3), of which at least one separation process only separates light-weight laminar partial fractions (2′″) due to the S-shaped laminar gas flow route (7), and that the S-shaped laminar flow is generated along the gas routing elements (5,6,9,11) due to the special smooth, seamless and lossless geometric design.

7. The method according to claim 1, wherein the gas/material stream (2″,2′″) is routed to a guide element (5) at least once, before it is routed into a circular-arch-like stream pattern (20).

8. A device for the separation of a heterogeneous material stream (2), preferably in the waste management industry, with a multi-part housing (3) having at least one cylindrically shaped part (11) and at least one gas injection nozzle (12) and at least one suction extraction unit (8) whereby the injected gas stream (4) discharged from the at least one gas injection nozzle (12) passes through the material stream (2) at least once thereby capturing the material fractions (2″, 2′″) to transport them in the direction of the at least one cylindrically shaped housing wall (11) to then, due to the curvature of the housing wall (11), further transport it in a circular-arc-like path in the direction towards the suction extraction unit (8), whereby at least one adjustable guide element (5) is arranged within the housing (3) below the cylindrically shaped housing wall (11), which controls the direction and speed of at least one gas/material stream (2″, 2′″) before it is routed to the cylindrical housing part (11) along a circular-arc-like path.

9. The device (1) according to claim 8, wherein least one part (11) of the housing (3) is shaped cylindrically, along which at least one fraction (2″′) of the material stream (2) is captured and carried along by the gas flow.

10. The device (1) according to claim 8, wherein a circular arc-like inner wall (11) of the cylindrically shaped part of the housing (3) has a predetermined radius of curvature r1.

11. The device (1) according to claim 8, wherein at least one gas injection nozzle (12) and at least one suction extraction unit (8) which extracts only one fraction (2′″).

12. The device (1) according to claim 8, wherein at least one curved and adjustable flow control element (6) is placed at the end (13) of the cylindrical housing component (11), which, at least in the vicinity of the extractor channel (8), controls the gas/material stream (2′″) with respect to direction and speed.

13. The device according to claim 8, wherein the suction extractor unit (8) is arranged tangentially in the end section of the circular-arc-like flow pattern of the gas/material stream (2″, 2′″).

14. The device according to claim 8, wherein the suction extraction unit (8) of the cylindrical housing component (11) is located on the curved housing wall in the area of a circular flight-path motion of the material stream (2″, 2′″) of 60° to 220°, preferably between 90° and 200°.

15. The device according to claim 8, wherein the fact that the end (14) of the at least one means of conveyance (15) is placed adjustably in the area of the inlet opening (16) of the housing (3).

16. The device according to claim 8, wherein at least one means of conveyance (15) is positioned below the primary gas stream (4).

17. The device according to claim 8, wherein the housing (3) has at least one maintenance hatch (17).

18. The device according to claim 8, wherein the line (7) along the cylindrical housing part (11) and the guide element (6) in the area of the suction extraction unit (8) is S-shaped-like.
